(19) United States
(12) Patent Application Publication
(10) Pub. No.: US 2026/0150168 A1
(43) Pub. Date: May 28, 2026

(54) LIGHTING DEVICE BASED ON SELF-LEARNING LIGHTING GROUP CONTROL MECHANISM AND METHOD THEREOF

(71) Applicant: Xiamen PVTECH Co., Ltd., Xiamen (CN)

(72) Inventors: CHENGQUAN XU, Xiamen (CN); ZHIRONG LIN, Xiamen (CN); FUXING LU, Xiamen (CN)

(21) Appl. No.: 19/378,403

(22) Filed: Nov. 4, 2025

(30) Foreign Application Priority Data
Nov. 27, 2024 (CN) 202411707941.9

(51) Int. Cl. H05B 47/115; H05B 47/155; H05B 47/175; H05B 47/19

(52) U.S. Cl. CPC H05B 47/115; H05B 47/155; H05B 47/19; H05B 47/198

(57) ABSTRACT

The disclosure discloses a lighting device based on self-learning lighting group control mechanism and the method thereof. The lighting device includes a detection module, a communication module and a processing module. The communication module receives a first broadcast signal having a first identifier. The processing module is connected to the detection module and the communication module. The processing module generates a time window and a learning item according to the time point at which the first broadcast signal is received and the signal strength of the first broadcast signal. The processing module increases the memory depth of the learning item when the detection module detects a moving object within the time window.

### TECHNICAL FIELD

The disclosure relates to a lighting device, in particular to a lighting device based on self-learning lighting group control mechanism. The disclosure further relates to the self-learning lighting group control method of the lighting device.

### BACKGROUND

With the advancement of technology, the functions of lighting devices have also been greatly improved, and a lighting system with group control capability can be realized. However, the installation process of a currently available lighting systems with group control capability requires complicated network configuration and network setup, which significantly increases the overall cost of the lighting system. In addition, technicians need to perform group configuration for each lighting device of the lighting system individually, which also consumes a large amount of labor cost and further increases the overall cost of the lighting system. Furthermore, the above-mentioned group configuration needs to be implemented through hardware switches (such as DIP switches), so the number of groups may also be limited by the hardware switches, thereby greatly restricting the application of the lighting system.

China Patent Publication NO. CN116507003A, Chinese Patent No. CN221103571U, and U.S. Patent Publication No. US20170181249A1 also disclose improved lighting systems, but still cannot effectively solve the above problems.

### SUMMARY

One embodiment of the disclosure provides a lighting device based on self-learning lighting group control mechanism, which includes a detection module, a communication module and a processing module. The communication module receives a first broadcast signal having a first identifier. The processing module is connected to the detection module and the communication module. The processing module generates a time window and a learning item according to the time point at which the first broadcast signal is received and the signal strength of the first broadcast signal. The processing module increases the memory depth of the learning item when the detection module detects a moving object within the time window.

Another embodiment of the disclosure provides a self-learning lighting group control method, which includes the following steps: receiving a first broadcast signal having a first identifier; generating a time window according to the time point at which the first broadcast signal is received and the signal strength of the first broadcast signal; generating a learning item; and increasing the memory depth of the learning item when a moving object is detected within the time window.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given herein below and the accompanying drawings which are given by way of illustration only, and thus are not limitative of the disclosure and wherein:

FIG. 1 is a block diagram of a lighting device based on self-learning lighting group control mechanism in accordance with a first embodiment of the disclosure.

FIG. 2 is a first schematic view of an operating state of the lighting device based on self-learning lighting group control mechanism in accordance with the first embodiment of the disclosure.

FIG. 3 is a schematic view of a time window of the lighting device based on self-learning lighting group control mechanism in accordance with the first embodiment of the disclosure.

FIG. 4 is a second schematic view of the operating state of the lighting device based on self-learning lighting group control mechanism in accordance with the first embodiment of the disclosure.

FIG. 5 is a schematic view of a lighting system in accordance with a second embodiment of the disclosure.

FIG. 6 is a flow chart of a self-learning lighting group control method in accordance with a third embodiment of the disclosure.

FIG. 7 is a flow chart of a self-learning lighting group control method in accordance with a fourth embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

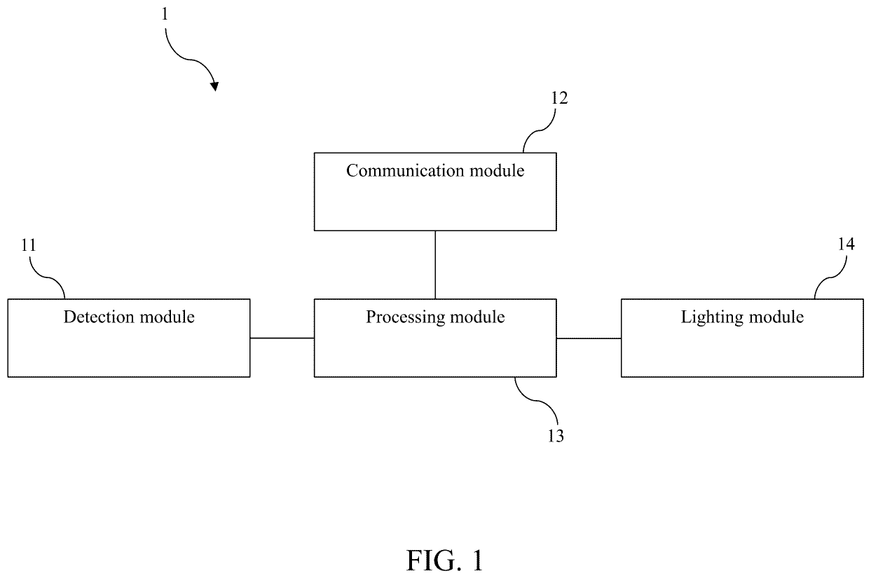

Please refer to FIG. 1, which is a block diagram of a lighting device based on self-learning lighting group control mechanism in accordance with a first embodiment of the disclosure. As shown in FIG. 1, the lighting device 1 includes a detection module 11, a communication module 12, a processing module 13, and a lighting module 14. The processing module 13 is connected to the detection module 11, the communication module 12, and the lighting module 14. In one embodiment, the processing module 13 may be a microcontroller unit (MCU). In another embodiment, the processing module 13 may also be a central processing unit (CPU), an application-specific integrated circuit (ASIC), a field-programmable gate array (FPGA), or other similar components. In one embodiment, the detection module 11 may be a microwave sensor. In another embodiment, the detection module 11 may also be an infrared sensor or other similar components. In one embodiment, the communication module 12 may be a Bluetooth™ module. In another embodiment, the communication module 12 may also be a WiFi™ module, a ZigBee™ module, or other similar components. In one embodiment, the lighting module 14 may be a light-emitting diode (LED). In another embodiment, the lighting module 14 may also be a bulb, a fluorescent lamp, or other similar components.

The embodiment just exemplifies the disclosure and is not intended to limit the scope of the disclosure; any equivalent modification and variation according to the spirit of the disclosure is to be also included within the scope of the following claims and their equivalents.

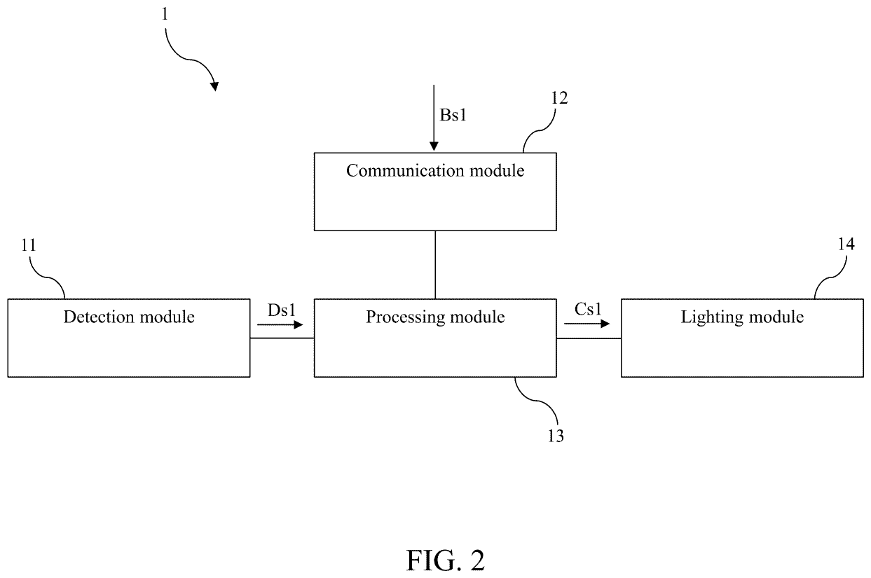

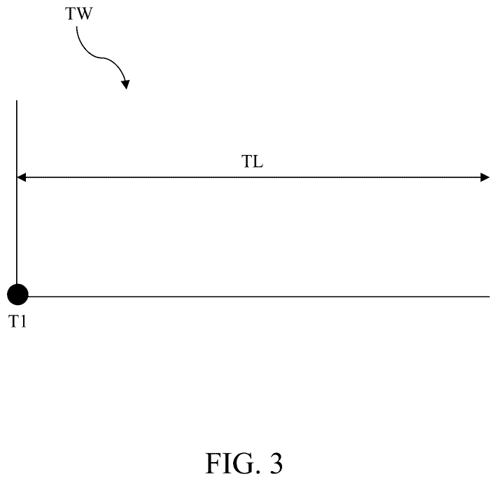

Please refer to FIG. 2 and FIG. 3. FIG. 2 is a first schematic view of an operating state of the lighting device based on self-learning lighting group control mechanism in accordance with the first embodiment of the disclosure. FIG. 3 is a schematic view of a time window of the lighting device based on self-learning lighting group control mechanism in accordance with the first embodiment of the disclosure. As shown in FIG. 2, the communication module 12 receives a first broadcast signal Bs1 having a first identifier and transmits the first broadcast signal Bs1 to the processing module 13. The first broadcast signal Bs1 may be generated by another lighting device 1 after detecting a moving object MV.

The processing module 13 generates a time window TW and a learning item corresponding to the first broadcast signal Bs1 according to the time point T1 at which the first broadcast signal Bs1 is received and the signal strength of the first broadcast signal Bs1. Then, the processing module 13 may store the learning item.

The detection module 11 may detect a moving object MV (such as a person or a vehicle). When the detection module 11 detects the moving object MV within the time window TW, a detection signal Ds1 is generated and transmitted to the processing module 13. The processing module 13 then increases the memory depth of the learning item. For example, the processing module 13 may increase the memory depth of the learning item by 1, which may be adjusted according to actual requirements.

As shown in FIG. 3, after receiving the first broadcast signal Bs1, the processing module 13 first determines whether the signal strength of the first broadcast signal Bs1 is greater than a preset learning threshold. When the signal strength of the first broadcast signal Bs1 is greater than the preset learning threshold, the processing module 13 performs a learning step. The learning threshold may be adjusted according to actual requirements and is related to the number of lighting devices 1 in the group. If the processing module 13 determines that the signal strength of the first broadcast signal Bs1 is greater than the preset learning threshold, the processing module 13 generates a time window TW and a learning item according to the time point T1 at which the first broadcast signal Bs1 is received and the signal strength of the first broadcast signal Bs1. The processing module 13 converts the signal strength of the first broadcast signal Bs1 into an estimated time length TL as the length of the time window TW and takes the time point T1 as the starting point of the time window TW. The processing module 13 may calculate the propagation distance of the first broadcast signal Bs1 according to the attenuation of the signal strength of the first broadcast signal Bs1, and divide the propagation distance by an estimated speed to generate the estimated time length TL. In this embodiment, the estimated speed may be the moving speed of a vehicle (such as 20 kilometers per hour, 15 kilometers per hour, 10 kilometers per hour, etc., which may be adjusted according to practical applications). In another embodiment, the estimated speed may also be the walking speed of a person (such as 3.2 kilometers per hour, 3.5 kilometers per hour, 5 kilometers per hour, 7 kilometers per hour, etc., which may be adjusted according to practical applications). That is, the processing module 13 can determine whether the moving object MV detected by a front lighting device 1 can be detected by the detection module 11 within the estimated time length TL.

The above-mentioned learning step may be automatically executed each time the processing module 13 receives the first broadcast signal Bs1. The processing module 13 determines the learning item as valid when the memory depth of the learning item exceeds a preset threshold. In this way, when the communication module 12 receives the first broadcast signal Bs1 next time, the processing module 13 directly generates a control signal Cs1 to activate the lighting module 14.

Through the above-mentioned self-learning based lighting group control mechanism, the lighting devices 1 can achieve automatic grouping without requiring complicated network configuration and network setup. Therefore, the installation cost of the lighting system 2 can be greatly reduced, such that the lighting system 2 can meet actual requirements.

In this embodiment, the lighting device 1 has a self-learning based lighting group control mechanism. The self-learning based lighting group control mechanism can achieve automatic grouping, so that complicated network configuration and network setup are not required, and labor cost is not increased, thereby further reducing the overall cost of the lighting system 2. Therefore, the practicality of the lighting system 2 can be greatly enhanced to meet practical application requirements.

In this embodiment, the processing module 13 of the lighting device 1 calculates the propagation distance of the first broadcast signal Bs1 according to the signal strength of the first broadcast signal Bs1, and divides the propagation distance by an estimated speed to generate an estimated time length TL. The processing module 13 takes the estimated time length TL as the length of the time window TW and takes the time point T1 as the starting point of the time window TW. Through the above-mentioned special calculation mechanism of the estimated time length TL and the time window TW generated based on the calculation mechanism, self-learning can be performed more effectively, so that the lighting device 1 can correctly estimate an approaching moving object MV to provide lighting functions appropriately. Therefore, the performance of the lighting system 2 can be greatly improved to meet the requirements of various applications.

In this embodiment, the lighting device 1 can accurately detect the moving object MV and activate in advance when the moving object MV is approaching, so as to provide lighting functions appropriately. Thus, the lighting device 1 can be applied not only in parking lots but also in office buildings or other buildings. Therefore, the lighting device 1 can be more comprehensive in application and more flexible in use.

In this embodiment, the functions of the lighting device 1 can be applied to realize various intelligent systems such as intelligent parking systems and intelligent home systems. Thus, the lighting device 1 can meet the needs of various intelligent applications and therefore can comply with future development trends.

The embodiment just exemplifies the disclosure and is not intended to limit the scope of the disclosure; any equivalent modification and variation according to the spirit of the disclosure is to be also included within the scope of the following claims and their equivalents.

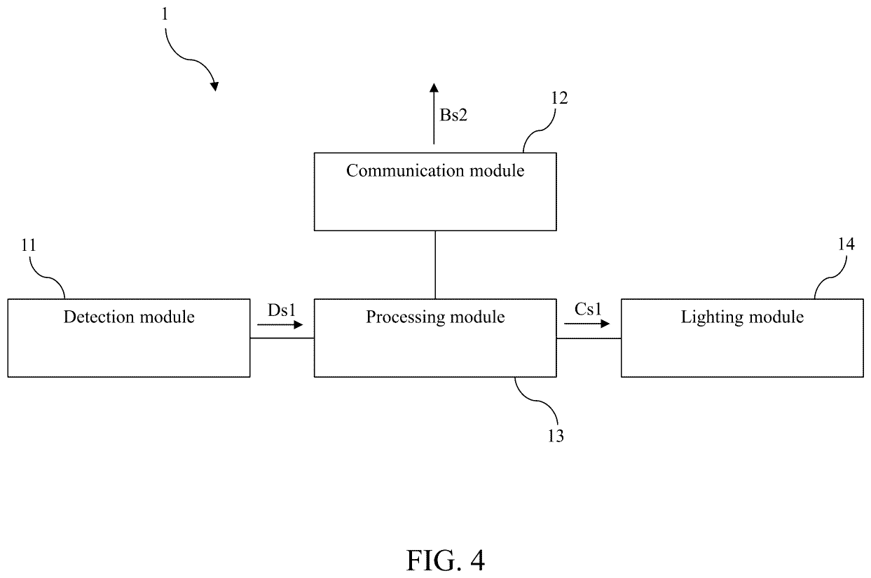

Please refer to FIG. 4, which is a second schematic view of the operating state of the lighting device based on self-learning lighting group control mechanism in accordance with the first embodiment of the disclosure. As shown in FIG. 4, the detection module 11 detects a moving object MV to generate a detection signal Ds1 and transmits it to the processing module 13. The processing module 13 then generates a control signal Cs1 to activate the lighting module 14 and controls the communication module 12 to broadcast a second broadcast signal Bs2 having a second identifier. The second broadcast signal Bs2 may be received by other lighting devices 1 to perform the above-mentioned learning step, thereby implementing the self-learning lighting group control mechanism.

The embodiment just exemplifies the disclosure and is not intended to limit the scope of the disclosure; any equivalent modification and variation according to the spirit of the disclosure is to be also included within the scope of the following claims and their equivalents.

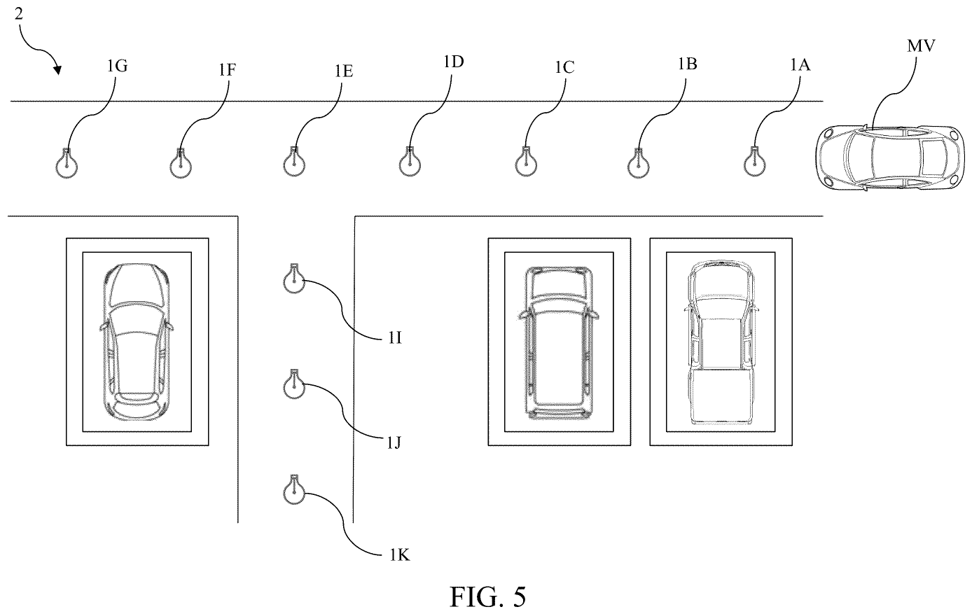

Please refer to FIG. 5, which is a schematic view of a lighting system in accordance with a second embodiment of the disclosure. As shown in FIG. 5, the lighting system 2 can be installed in a parking lot and can include ten lighting devices 1A to 1K (the number of lighting devices 1A to 1K is merely exemplary and can be adjusted according to actual requirements). The lighting devices 1A, 1B, and 1C can form a first group. The lighting devices 1D, 1E, 1F, and 1G can form a second group. The lighting devices 1I, 1J, and 1K can form a third group. The lighting devices 1B and 1C can perform the above learning steps based on the broadcast signal of the lighting device 1A. The lighting devices 1E, 1F, and 1G can perform the above learning steps based on the broadcast signal of the lighting device 1D. The lighting devices 1J and 1K can perform the above learning steps based on the broadcast signal of the lighting device 1I.

Taking the first group as an example, when the lighting device 1A detects a moving object MV, the lighting device 1A broadcasts a first broadcast signal Bs1 with a first identifier. When the lighting device 1B receives the first broadcast signal Bs1, the lighting device 1B determines whether the signal strength of the first broadcast signal Bs1 is greater than a preset learning threshold. When the lighting device 1B determines that the signal strength of the first broadcast signal Bs1 is greater than the preset learning threshold, the lighting device 1B generates a time window TW and a learning item based on the time point T1 at which the first broadcast signal Bs1 is received and the signal strength of the first broadcast signal Bs1. When the lighting device 1B detects the moving object MV within the time window TW, the lighting device 1B increases the memory depth of the learning item by 1. When the memory depth of the learning item exceeds a preset threshold, the lighting device 1B determines that the learning item is valid. Thus, when the lighting device 1B next receives the first broadcast signal Bs1, the lighting device 1B directly starts. The lighting device 1C performs the same learning steps. The second group and the third group also perform the same steps.

In another embodiment, each of lighting devices 1A to 1K can perform detection operations and learning steps.

In this embodiment, through the above self-learning lighting group control mechanism, the lighting devices 1 can achieve automatic grouping without requiring complex network settings and network construction. Therefore, the installation cost of the lighting system 2 can be greatly reduced, making the lighting system 2 more suitable for actual application requirements.

In this embodiment, the lighting device has a self-learning lighting group control mechanism. The above self-learning lighting group control mechanism can achieve automatic grouping, so complex network settings and network construction are not required, nor will labor costs be increased, thereby further reducing the overall cost of the lighting system 2. Therefore, the practicality of the lighting system 2 can be greatly enhanced to meet actual application requirements.

In addition, in this embodiment, the processing module 13 of the lighting device calculates the propagation distance of the first broadcast signal Bs1 according to the signal strength of the first broadcast signal Bs1, and divides the propagation distance by an estimated speed to generate an estimated time length TL. The processing module 13 uses the estimated time length TL as the length of the time window TW and uses the time point T1 as the starting point of the time window TW. Through the above special estimated time length calculation mechanism and the time window TW generated based on this calculation mechanism, self-learning can be performed more effectively, allowing the lighting device to correctly estimate an approaching moving object MV and appropriately provide lighting functions. Therefore, the performance of the lighting system 2 can be greatly improved to meet various application requirements.

Furthermore, in this embodiment, the lighting device can accurately detect a moving object MV and start in advance when the moving object MV approaches to appropriately provide lighting functions. Thus, the lighting device can not only be applied in parking lots but also in office buildings or other constructions. Therefore, the lighting device can be applied more widely and used more flexibly.

Moreover, in this embodiment, the functions of the lighting device can be used to realize various intelligent systems (such as an intelligent parking lot system, intelligent home system, etc.). Thus, the lighting device can meet the requirements of various intelligent applications and conform to future development trends.

The embodiment just exemplifies the disclosure and is not intended to limit the scope of the disclosure; any equivalent modification and variation according to the spirit of the disclosure is to be also included within the scope of the following claims and their equivalents.

It is worthy to point out that the installation process of the currently available lighting systems with group control capability requires complicated network configuration and network setup, which significantly increases the overall cost of the lighting system. In addition, technicians need to perform group configuration for each lighting device of the lighting system individually, which also consumes a large amount of labor cost and further increases the overall cost of the lighting system. Furthermore, the above-mentioned group configuration needs to be implemented through hardware switches (such as DIP switches), so the number of groups may also be limited by the hardware switches, thereby greatly restricting the application of the lighting system. By contrast, according to the first embodiment, second embodiment, third embodiment, and fourth embodiment of the present invention, the lighting device 1 includes a detection module 11, a communication module 12, a processing module 13, and a lighting module 14. The communication module 12 is configured to receive a first broadcast signal Bs1 having a first identifier. The processing module 13 is connected to the detection module 11 and the communication module 12. The processing module 13 generates a time window TW and a learning item according to the time point T1 at which the first broadcast signal Bs1 is received and the signal strength of the first broadcast signal Bs1, and increases the memory depth of the learning item when the detection module 11 detects a moving object MV within the time window TW. The processing module 13 determines the learning item as valid when the memory depth of the learning item exceeds a preset threshold, and activates the lighting module 14 when the communication module 12 next receives the first broadcast signal Bs1. Through the above-mentioned self-learning based lighting group control mechanism, the lighting devices 1 can achieve automatic grouping without requiring complicated network configuration and network setup. Therefore, the installation cost of the lighting system 2 can be greatly reduced, such that the lighting system 2 can meet actual requirements.

Also, according to the first embodiment, second embodiment, third embodiment, and fourth embodiment of the present invention, the lighting device 1 has a self-learning based lighting group control mechanism. The self-learning based lighting group control mechanism can achieve automatic grouping, so that complicated network configuration and network setup are not required, and labor cost is not increased, thereby further reducing the overall cost of the lighting system 2. Therefore, the practicality of the lighting system 2 can be greatly enhanced to meet actual requirements.

Further, according to the first embodiment, second embodiment, third embodiment, and fourth embodiment of the present invention, the processing module 13 of the lighting device 1 calculates the propagation distance of the first broadcast signal Bs1 according to the signal strength of the first broadcast signal Bs1, and divides the propagation distance by an estimated speed to generate an estimated time length TL. The processing module 13 takes the estimated time length TL as the length of the time window TW, and takes the time point T1 as the starting point of the time window TW. Through the above-mentioned special calculation mechanism of the estimated time length TL and the time window TW generated based on the calculation mechanism, self-learning can be performed more effectively, so that the lighting device 1 can correctly estimate an approaching moving object MV to provide lighting functions appropriately. Therefore, the performance of the lighting system 2 can be greatly improved to meet the requirements of various applications.

Moreover, according to the first embodiment, second embodiment, third embodiment, and fourth embodiment of the present invention, the lighting device 1 can accurately detect a moving object MV and activate in advance when the moving object MV is approaching, so as to provide lighting functions appropriately. Thus, the lighting device 1 can be applied not only in parking lots but also in office buildings or other buildings. Therefore, the lighting device 1 can be more comprehensive in application and more flexible in use.

Furthermore, according to the first embodiment, second embodiment, third embodiment, and fourth embodiment of the present invention, the functions of the lighting device 1 can be applied to realize various intelligent systems (such as intelligent parking systems, intelligent home systems, etc.). Thus, the lighting device 1 can meet the needs of various intelligent applications and therefore can comply with future development trends. As set forth above, the lighting device based on self-learning lighting group control mechanism according to the embodiments of the disclosure can definitely achieve great technical effects.

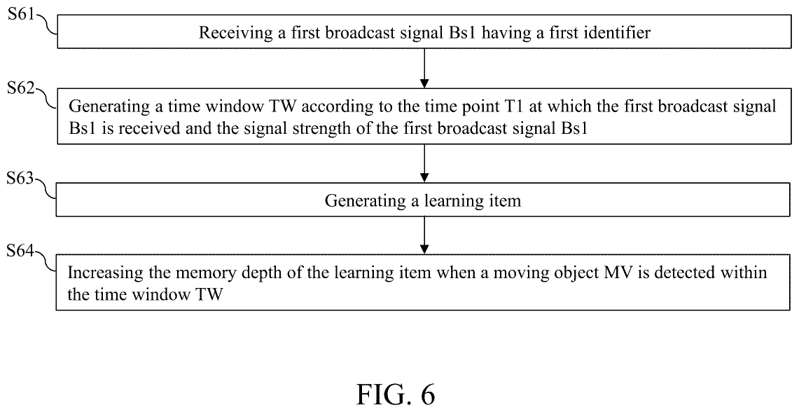

Please refer to FIG. 6, which is a flow chart of a self-learning lighting group control method in accordance with a third embodiment of the disclosure. As shown in FIG. 6, the self-learning lighting group control method of this embodiment includes the following steps:

Step S61: receiving a first broadcast signal Bs1 having a first identifier.

Step S62: generating a time window TW according to the time point T1 at which the first broadcast signal Bs1 is received and the signal strength of the first broadcast signal Bs1.

Step S63: generating a learning item.

Step S64: increasing the memory depth of the learning item when a moving object MV is detected within the time window TW.

The embodiment just exemplifies the disclosure and is not intended to limit the scope of the disclosure; any equivalent modification and variation according to the spirit of the disclosure is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

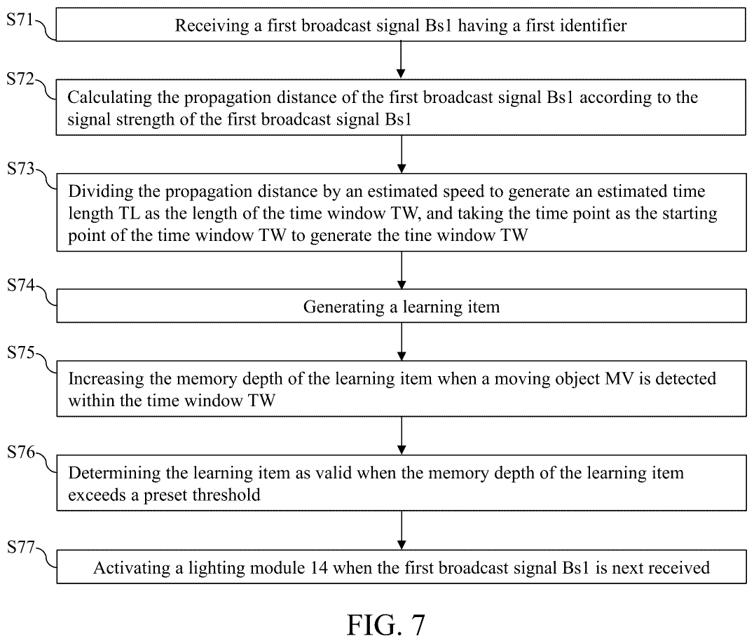

Please refer to FIG. 7, which is a flow chart of a self-learning lighting group control method in accordance with a fourth embodiment of the disclosure. As shown in FIG. 7, the self-learning lighting group control method of this embodiment includes the following steps:

Step S71: receiving a first broadcast signal Bs1 having a first identifier.

Step S72: calculating the propagation distance of the first broadcast signal Bs1 according to the signal strength of the first broadcast signal Bs1.

Step S73: dividing the propagation distance by an estimated speed to generate an estimated time length TL as the length of the time window TW, and taking the time point as the starting point of the time window TW to generate the tine window TW.

Step S74: generating a learning item.

Step S75: increasing the memory depth of the learning item when a moving object MV is detected within the time window TW.

Step S76: determining the learning item as valid when the memory depth of the learning item exceeds a preset threshold.

Step S77: activating a lighting module 14 when the first broadcast signal Bs1 is next received.

The embodiment just exemplifies the disclosure and is not intended to limit the scope of the disclosure; any equivalent modification and variation according to the spirit of the disclosure is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to the first embodiment, second embodiment, third embodiment, and fourth embodiment of the present invention, the lighting device 1 includes a detection module 11, a communication module 12, a processing module 13, and a lighting module 14. The communication module 12 is configured to receive a first broadcast signal Bs1 having a first identifier. The processing module 13 is connected to the detection module 11 and the communication module 12. The processing module 13 generates a time window TW and a learning item according to the time point T1 at which the first broadcast signal Bs1 is received and the signal strength of the first broadcast signal Bs1, and increases the memory depth of the learning item when the detection module 11 detects a moving object MV within the time window TW. The processing module 13 determines the learning item as valid when the memory depth of the learning item exceeds a preset threshold, and activates the lighting module 14 when the communication module 12 next receives the first broadcast signal Bs1. Through the above-mentioned self-learning based lighting group control mechanism, the lighting devices 1 can achieve automatic grouping without requiring complicated network configuration and network setup. Therefore, the installation cost of the lighting system 2 can be greatly reduced, such that the lighting system 2 can meet actual requirements.

Also, according to the first embodiment, second embodiment, third embodiment, and fourth embodiment of the present invention, the lighting device 1 has a self-learning based lighting group control mechanism. The self-learning based lighting group control mechanism can achieve automatic grouping, so that complicated network configuration and network setup are not required, and labor cost is not increased, thereby further reducing the overall cost of the lighting system 2. Therefore, the practicality of the lighting system 2 can be greatly enhanced to meet actual requirements.

Further, according to the first embodiment, second embodiment, third embodiment, and fourth embodiment of the present invention, the processing module 13 of the lighting device 1 calculates the propagation distance of the first broadcast signal Bs1 according to the signal strength of the first broadcast signal Bs1, and divides the propagation distance by an estimated speed to generate an estimated time length TL. The processing module 13 takes the estimated time length TL as the length of the time window TW, and takes the time point T1 as the starting point of the time window TW. Through the above-mentioned special calculation mechanism of the estimated time length TL and the time window TW generated based on the calculation mechanism, self-learning can be performed more effectively, so that the lighting device 1 can correctly estimate an approaching moving object MV to provide lighting functions appropriately. Therefore, the performance of the lighting system 2 can be greatly improved to meet the requirements of various applications.

Moreover, according to the first embodiment, second embodiment, third embodiment, and fourth embodiment of the present invention, the lighting device 1 can accurately detect a moving object MV and activate in advance when the moving object MV is approaching, so as to provide lighting functions appropriately. Thus, the lighting device 1 can be applied not only in parking lots but also in office buildings or other buildings. Therefore, the lighting device 1 can be more comprehensive in application and more flexible in use.

Furthermore, according to the first embodiment, second embodiment, third embodiment, and fourth embodiment of the present invention, the functions of the lighting device 1 can be applied to realize various intelligent systems (such as intelligent parking systems, intelligent home systems, etc.). Thus, the lighting device 1 can meet the needs of various intelligent applications and therefore can comply with future development trends.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is

1. A lighting device based on self-learning lighting group control mechanism, comprises:
a detection module;
a communication module configured to receive a first broadcast signal having a first identifier; and
a processing module connected to the detection module and the communication module;
wherein the processing module is configured to generate a time window and a learning item according to a time point at which the first broadcast signal is received and a signal strength of the first broadcast signal, wherein the processing module is configured to increase a memory depth of the learning item when the detection module detects a moving object within the time window.

2. The lighting device based on self-learning lighting group control mechanism as claimed in claim 1, wherein the processing module is configured to convert the signal strength of the first broadcast signal into an estimated time length as a length of the time window, and take the time point as a starting point of the time window.

3. The lighting device based on self-learning lighting group control mechanism as claimed in claim 2, wherein the processing module is configured to calculate a propagation distance of the first broadcast signal according to the signal strength of the first broadcast signal, and divide the propagation distance by an estimated speed to generate the estimated time length.

4. The lighting device based on self-learning lighting group control mechanism as claimed in claim 1, further comprising a lighting module, wherein the processing module is configured to determine the learning item as valid when the memory depth of the learning item exceeds a preset threshold, and activate the lighting module when the communication module next receives the first broadcast signal.

5. The lighting device based on self-learning lighting group control mechanism as claimed in claim 1, further comprising a lighting module, wherein the processing module is configured to control the communication module to broadcast a second broadcast signal having a second identifier and activate the lighting module when the detection module detects the moving object or another moving object.

6. A self-learning lighting group control method, comprises:
receiving a first broadcast signal having a first identifier;
generating a time window according to a time point at which the first broadcast signal is received and a signal strength of the first broadcast signal;
generating a learning item; and
increasing a memory depth of the learning item when a moving object is detected within the time window.

7. The self-learning lighting group control method as claimed in claim 6, wherein a step of generating the time window according to the time point at which the first broadcast signal is received and the signal strength of the first broadcast signal further comprises:
converting the signal strength of the first broadcast signal into an estimated time length as a length of the time window; and
taking the time point as a starting point of the time window.

8. The self-learning lighting group control method as claimed in claim 7, wherein a step of converting the signal strength of the first broadcast signal into the estimated time length as the length of the time window further comprises:
calculating a propagation distance of the first broadcast signal according to the signal strength of the first broadcast signal; and
dividing the propagation distance by an estimated speed to generate the estimated time length.

9. The self-learning lighting group control method as claimed in claim 6, further comprises:
determining the learning item as valid when the memory depth of the learning item exceeds a preset threshold; and
activating a lighting module when the first broadcast signal is next received.

10. The self-learning lighting group control method as claimed in claim 6, further comprises:
broadcasting a second broadcast signal having a second identifier when the moving object or another moving object is detected; and
activating a lighting module.
